(19) United States
(12) Patent Application Publication
(10) Pub. No.: US 2011/0311766 A1
(43) Pub. Date: Dec. 22, 2011

(54) NAPKIN HAVING AN INTEGRATED RING AND METHOD OF MAKING THE SAME

(75) Inventor: Michelle Edgemont, Brooklyn, NY (US)

(73) Assignee: Ex-Cell Home Fashions, Inc.

(21) Appl. No.: 12/818,530

(22) Filed: Jun. 18, 2010

(51) Int. Cl. B32B 3/10; D05B 23/00; B23P 17/04

(52) U.S. Cl. 428/136; 29/428; 112/475.08; 428/131; 428/134

(57) ABSTRACT

A napkin having an integrated napkin ring and a method of making the napkin are provided. The method may include forming an opening in a napkin such that a center of the opening is located in a position offset from the center of the napkin. The method may further include attaching a ring or grommet to the napkin and around the opening such that an interior circumference of the ring or grommet defines the opening. In various embodiments, the opening may be a variety of shapes and sizes and may have a periphery that is sewn. The ring or grommet may be a variety of shapes, sizes, colors, and materials. Interior and exterior edges of the ring or grommet may be the same or different in shape, while first and second sides of the ring or grommet may be the same or different in color and/or material.

### BACKGROUND

The present invention relates to a napkin ring having an integrated ring and a method of making the same.

Traditionally, napkins and napkin rings have been separately manufactured and distributed, only to be integrally used after purchase by consumers. This model of having two independent items provides a great deal of flexibility for consumers, permitting personalized purchases and interchangeability of both the napkins and the napkin rings. Even so, consumers are often frustrated when they cannot subsequently replace a broken or lost napkin ring, such as when manufacturers have discontinued a certain napkin ring. Further, in recent years as consumers are becoming more aware of the environmental impact of the products they buy, many consumers prefer more simplistic and livable items.

Therefore, it would be beneficial to provide a napkin and napkin ring alternative solution that is economical, simplistic, and livable while preferably not entirely sacrificing consumer flexibility or the aesthetic or useful characteristics of the napkin and napkin ring.

### BRIEF SUMMARY

One or more embodiments of a napkin having an integrated ring and a method of making the napkin are disclosed herein that may address one or more of the above issues. According to embodiments of the present invention, a napkin is provided that includes an opening through which at least a portion of the napkin may be placed to create an aesthetic presentation of the napkin, such as, for example, where a portion of the napkin flairs outwardly from the opening. In certain embodiments, a center of the opening may be located at a position that is offset from a center of the napkin. The napkin may be substantially square with a perimeter having four sides or it may be substantially circular. In those embodiments having a square napkin, the center of the opening may be located a distant equidistant to two adjacent sides of the perimeter. In certain of those embodiments, the distance may be approximately ⅛ to ⅜ of a length of one of the four sides of the napkin. In still other of those embodiments, the distance may be approximately ¼ the length of one of the four sides. Where the length of each of the four sides is approximately eighteen inches (18″) the distance is approximately four and a half inches (4.5″). In those embodiments having a circular napkin, the center of the opening may be located a distance from the perimeter that is approximately ⅛ to ¾ of a radius of the napkin. In certain of those embodiments, the distance may be approximately ½ of the radius.

In certain embodiments, the opening may be substantially circular, square, or a slit. In some embodiments, the opening may have a periphery that is sewn. In other embodiments, a napkin and ring assembly may include a decoration attached around a circumference of the opening. For example, the decoration may include ribbons, beads, or similar aesthetically pleasing and attachable items.

In still other embodiments, a napkin and ring assembly may include a ring having an exterior circumference and an interior circumference defining the opening. The exterior may be substantially circular or square and the interior circumference may likewise, but independently, be substantially circular or square.

Some embodiments include a grommet as part of the napkin and ring assembly. The grommet may define the opening and may be made of plastic, ceramic, or metal. A grommet may include a first side portion and a second side portion. The first and second side portions may be different colors and/or different materials. A grommet may be selectively removable from and selectively attachable to the napkin.

Other embodiments of the present invention provide methods of making or manufacturing a napkin having an integrated napkin ring. For example, according to an embodiment, a method includes forming an opening in a napkin having a center and a perimeter such that a center of the opening is located in a position offset from the center of the napkin. The step of forming an opening may further involve positioning the center of the opening at a distance from the perimeter of the napkin that is less than ⅜ of a length of the perimeter. The step of forming an opening may also further involve sewing the napkin around a circumference of the opening. A method may also or alternatively comprise attaching a ring to the napkin and around the opening such that an interior circumference of the ring defines the opening.

These and other features and advantages of the present invention will become apparent to one skilled in the art upon examination of the following drawings and detailed description. It is intended that all such features and advantages be included herein within the scope of the present invention.

### BRIEF DESCRIPTION OF THE SEVERAL VIEWS OF THE DRAWING(S)

Reference will now be made to the accompanying drawings, which are not necessarily drawn to scale, and wherein:

FIG. 1 is a top view of a napkin and ring assembly consistent with an embodiment;

FIG. 2A is a top view of a napkin and ring assembly including a grommet, as consistent with another embodiment;

FIG. 2B is a bottom view of the napkin and ring assembly of FIG. 2A;

FIG. 3 is a top view of a napkin and ring assembly consistent with yet another embodiment; and

FIG. 4 is a perspective view of the napkin and ring assembly of FIG. 1 when pulled through the napkin ring in a manner consistent with the disclosed method.

### DETAILED DESCRIPTION

Various embodiments of the present invention now will be described more fully hereinafter with reference to the accompanying drawings, in which some, but not all embodiments of the inventions are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

Napkin

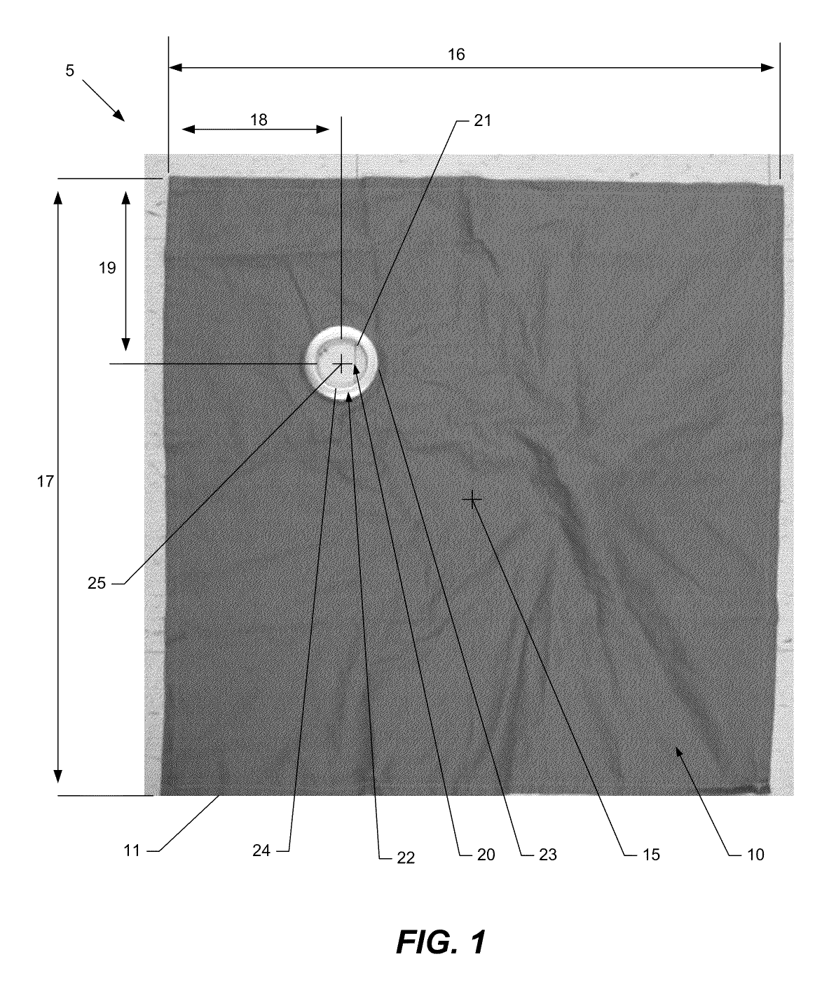

FIG. 1 illustrates a napkin and ring assembly 5 according to various embodiments of the present invention. The napkin and ring assembly 5 includes a napkin 10, which includes a perimeter 11 and a center 15. In certain embodiments, the napkin 10 is substantially square and the perimeter 11 comprises four sides that form edges of the napkin. The four sides, according to those embodiments, have a length 16 that is the same for each of the four sides. In one embodiment, the length 16 of each of the four sides is approximately eighteen inches (18″). In other embodiments, the length 16 of each of the four sides is twenty to twenty-two inches (20-22″). In still other embodiments, the length 16 of each of the four sides may be any dimension, including those known and used in the art of napkins.

In various embodiments, the napkin 10 may be substantially rectangular, circular, oval, or any of a variety of other desired shapes, including those known and used in the art of napkins. According to those embodiments having a substantially rectangular napkin 10, the perimeter 11 comprises four sides, with a first set of two opposing sides having a length 16 and a second set of two opposing sides having a length 17. In certain embodiments having a rectangular napkin 10, the length 16 and the length 17 are not substantially the same. In one embodiment, the length 16 is approximately eighteen inches (18″) while the length 17 is approximately twenty inches (20″). In other embodiments, the lengths 16 and 17 of the two sets of four sides may be any dimension, including those known and used in the art of napkins. According to those embodiments having a substantially circular napkin 110, a perimeter 111 defines a circumference of the napkin. In certain embodiments, the circumference is approximately fifty to one hundred inches in length (50-100″).

In various embodiments, the napkin may be constructed of a fabric material. The fabric material may include, but is not limited to, linen, cotton, polyester, rayon, nylon, acrylic, acetate, or any combination of the same. In other embodiments, the napkin may be constructed of one or more of a variety of fabric and non-fabric materials, such as flexible materials including but not limited to, vinyl and paper, as known and understood in the art of napkins.

Opening

In various embodiments, as shown in FIG. 1, the napkin 10 further includes an opening 20. The opening 20 includes a center 25 and a periphery 21. In certain embodiments, the opening is substantially circular; though in other embodiments, the opening may be substantially square or a slit. In still other embodiments, the opening may be circular, slit, elongated, oval or similarly shaped, or any other opening shape, including those known and understood in the arts of napkin rings, rings, or grommets. In various embodiments, the periphery 21 of the opening 20 is sewn, which in certain embodiments may include a decorative stitch, a lockstitch, or embroidery, such as in like manner of a button hole. In still other embodiments, a decoration, such as, for example, a ribbon or a bead or a similarly fashioned item may be placed around all or a portion of the periphery 21 of the opening 20, including those known or understood in the arts of napkins, table cloths, curtains, and like decorative textile goods, as well as decorative clothing and house wares.

The opening 20 is sized to receive at least a portion of the napkin 10 therethrough. In certain embodiments having a circular opening 20, the opening may have a diameter of approximately two inches (2″). In other embodiments, the diameter of the opening 20 may be approximately one to three inches (1-3″). In certain embodiments having a substantially square or rectangular opening 20, a length of one of the sides of the square or rectangular opening may be approximately two inches (2″). In other of those embodiments, the length of one of the sides may be approximately one to three inches (1-3″). In certain embodiments having a slit opening 20, the length of the slit may be approximately one to three inches (1-3″). In various other embodiments, the size of the opening 20 may be any size as known or understood in the art as being sufficient to permit at least a portion of the napkin 10 to be received there through.

Center Offset

In various embodiments, the opening 20 is offset from the center 15 of the napkin 10. For example, in certain embodiments, the center 25 of the opening 20 is located a first distance 18 and a second distance 19 from the perimeter 11 of the napkin 10. In certain embodiments, the first distance 18 and the second distance 19 are identical, such that the center 25 is located equidistant in the two adjacent directions from the perimeter 11 of the napkin. In other embodiments, the first distance 18 and the second distance 19 may be different, such that the center 25 is not located equidistance in all directions from the perimeter 11 of the napkin 10. In several of those embodiments having a substantially square or rectangular napkin 10, the distances 18 and 19 are approximately ⅛ to ⅜ of the lengths 16 and 17 of the sides formed by the perimeter 11. In other substantially square or rectangular napkin embodiments, the distances 18 and 19 are approximately ¼ of the lengths 16 and 17 of the sides. In one embodiment where the lengths 16 and 17 are approximately eighteen inches (18″), the first distance 18 and the second distance 19 are approximately four and half inches (4.5″). In other embodiments, the first and second distances 18 and 19 may be expressed as any ratio less than a one-to-two ratio relative to the lengths 16 and 17. Ratios of less than one-to-two may provide the center 25 of the opening 20 to be offset from (i.e., does not align with) the center 15 of the napkin 10. This configuration enables the napkin 10 to replicate a traditionally desirable flair shape when at least a portion of the napkin 10 is pulled through the opening 20.

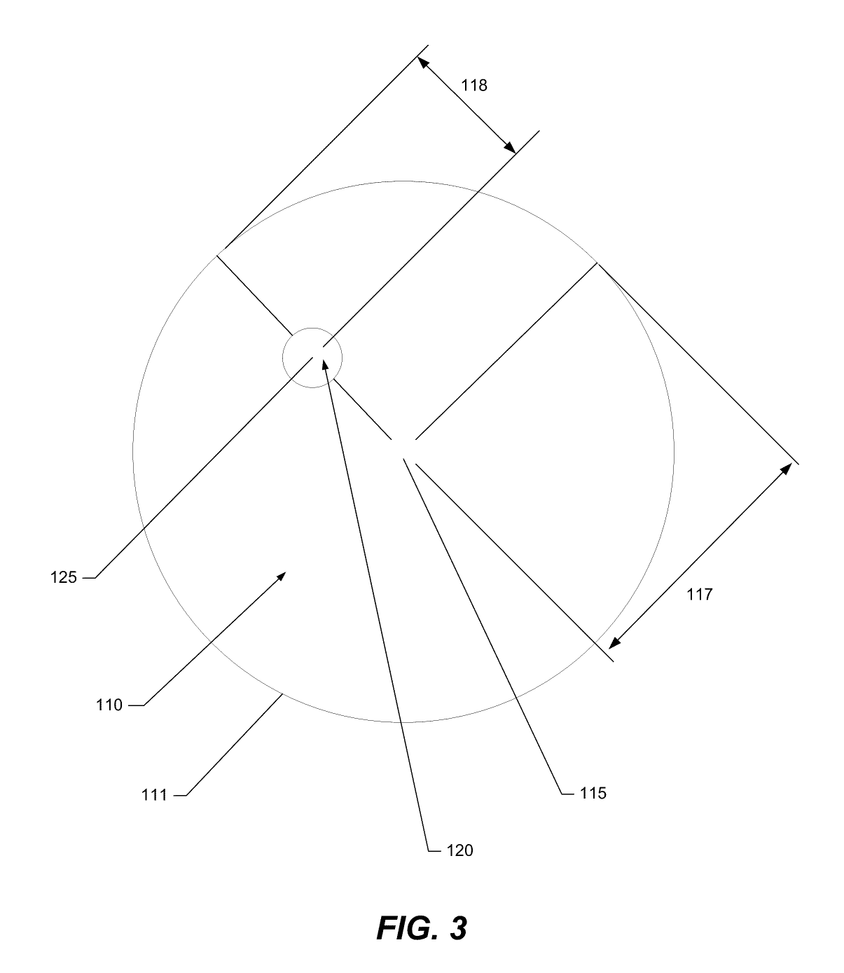

In certain embodiments having a substantially circular napkin 110, as shown in FIG. 3, e center 125 of the opening 120 is located a distance 118 from the perimeter 111 of the napkin 110 that is approximately ⅛ to ¾ of a radius 117 of the napkin 10. In other embodiments, the distance 118 is approximately ½ of the radius of the napkin.

Ring

In various embodiments, the napkin and ring assembly 5 includes a ring 22 having an exterior edge 23 and an interior edge 24. The interior edge 24, according to various embodiments, defines the opening 20. In certain embodiments, the exterior edge 23 may be substantially circular, thereby defining an exterior circumference of the ring 22. In other embodiments, the exterior edge 23 may be substantially square, triangular, trapezoidal, star-shaped, snowflake shaped, or any other shape as commonly known or understood in the art to be desirable to consumers. The interior edge 24, according to certain embodiments, may be substantially circular in shape, thereby defining an interior circumference of the ring 22 that likewise defines the opening 20. In other embodiments, the interior edge 24 may be substantially square, rectangular, or any other shape as commonly known or understood in the art to be capable of receiving at least a portion of the napkin 10 therethrough.

In one embodiment, for example, as illustrated in FIG. 1, both the interior edge 24 and the exterior edge 23 of the ring 22 are substantially circular. In another embodiment, for example, both edges 23 and 24 are substantially square. In yet another embodiment, the interior edge 24 is substantially circular while the exterior edge 23 is substantially square. A variety of additional combinations of edges 23 and 24 may be created, as known or understood in the arts.

In various embodiments, the ring 22 is sized to receive at least a portion of the napkin 10 therethrough. In certain embodiments having a circular ring 22, the ring has an interior diameter (defined by the interior edge 24) of approximately two inches (2″). In other of those embodiments, the diameter of the ring 22 may be approximately one to three inches (1-3″). In certain embodiments having a substantially square, triangular, or rectangular ring 22, a length of one of the sides of the square or rectangular ring may be approximately two inches (2″). In other of those embodiments, the length of one of the sides may be approximately one to three inches (1-3″). In various other embodiments, the size of the ring 22 may be any size as commonly known or understood in the art as being sufficient to permit at least a portion of the napkin 10 to be received there through.

In various embodiments, the ring 22 may be constructed from one or more of a variety of materials, as known or understood in the arts. In certain embodiments, for example, the ring 22 may be constructed of a plastic material. The plastic material may include, but is not limited to polycarbonate, polyvinyl chloride (vinyl), polyethylene terephthalate (PET), low or high density polyethylene (LDPE or HDPE), or any combination or alternative of the same, as known or understood in the arts. In other embodiments, the ring 22 may be constructed of a ceramic material. The ceramic material may include, but is not limited to crystalline ceramics and non-crystalline ceramics, as known and understood in the arts. In still other embodiments, the ring 22 is constructed of a metal material. The metal material may include, but is not limited to aluminum, copper, nickel, steel, brass, silver, tin, or any combination of the same or other like materials, as known and understood in the arts.

In various embodiments, the ring 22 may be configured to be selectively attachable to and selectively removable from the napkin 10. In certain embodiments, the ring 22 may include a recessed groove (not shown) adapted to receive a portion of the periphery 21 of the opening 20. In those embodiments, the ring 22 is sized to have an interference fit with the periphery 21 of the opening 20, such that the ring 22 cannot inadvertently be removed from the napkin without application of some degree of force by a consumer. In other embodiments, the ring 22 is configured to be operatively (e.g., permanently) attached to the napkin 10. In those embodiments, the ring 22 may be constructed of a machine- or hand-washable material to ensure longevity of the ring 22 during the lifecycle of a repeatedly laundered napkin. In still other embodiments, even where the ring 22 may be selectively removable from the napkin 10, the ring 22 may be constructed of a machine- or hand-washable material, such as in the vent that the ring 22 is not removed for washing, the ring is not damaged.

Grommet

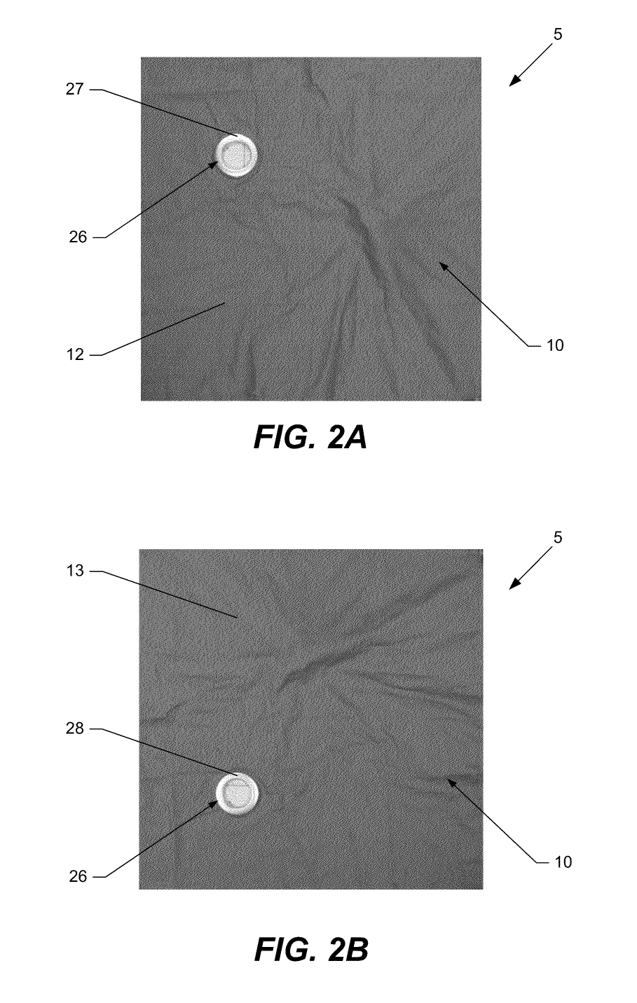

In various embodiments, as shown in FIGS. 2A and 2B, the ring 22 is a grommet 26. The grommet 26, according to various embodiments, includes exterior and interior edges that are shaped and sized in substantially the same manner as more generally disclosed above with respect to a ring 22. For example, the grommet 26 may be substantially circular and have a diameter of approximately one to three inches (1-3″). Alternatively, the grommet 26 may be substantially square, rectangular, or triangular, or any other shape as known or understood in the arts, such that the grommet remains capable of receiving at least a portion of the napkin 10 therethrough. In those embodiments, a length of one of the sides of the grommet 26 may be approximately one to three inches (1-3″). As described above with respect to a ring 22, the exterior and interior edges of the grommet 26 may each have a substantially different shape. The grommet 26, according to various embodiments, also serves to define the opening 20 in substantially the same manner as more generally disclosed above with respect to the ring 22.

As described above with respect to a ring 22, a grommet 26 may be constructed of one or more of a variety of materials. For example, in various embodiments, the grommet 26 may be constructed of a plastic material. In other embodiments, the grommet 26 may be constructed of a ceramic material. In still other embodiments, the grommet 26 may be constructed of a metal material.

According to various embodiments, with reference to FIGS. 2A and 2B, a grommet 26 may include a first side 27 and a second side 28. In certain embodiments, the first side 27 has a finish that is a first color (e.g., gold) while the second side 28 has a finish that is a second color (e.g., silver). In other embodiments, the finishes or colors of the first and second sides 27 and 28 of the grommet 26 may be substantially the same. Similarly, in certain embodiments, the first side 27 is constructed of a first material (e.g., plastic) while the second side 28 is constructed of a second material (e.g., brass). In other embodiments the materials of the first and second sides 27 and 28 of the grommet 26 may be substantially the same. In any of these embodiments, the consumer is given flexibility to customize the material, finish, and/or color of the grommet 26 when attaching the grommet to the napkin 10.

As with the ring 22, in various embodiments, the grommet 26 may be configured to be selectively attachable to and selectively removable from the napkin 10. In other embodiments, the grommet 26 may be configured to be operatively (e.g., permanently) attached to the napkin 10. In any of the disclosed embodiments having a grommet 26, the grommet is configured, as commonly known and understood in the art, to be attached to the napkin 10. In various embodiments, the grommet 26 may be constructed of a machine- or hand-washable material to ensure longevity of the grommet 26 during the lifecycle of a repeatedly laundered napkin.

Methods

In various embodiments, to make the napkin and ring assembly 5, a manufacturer or similarly situated individual forms an opening 20 in a napkin 10. A center 25 of the opening 20 is generally offset a particular distance from a center 15 of the napkin 10. In certain embodiments, the opening 20 is formed by positioning center 25 of the opening a distance from a periphery 11 of the napkin that is less than ⅜ of a length of the periphery. In one embodiment, forming the opening 20 and ring includes sewing the napkin 10 around an exterior circumference of the opening.

In various embodiments, to make the napkin and ring assembly 5, the manufacturer or similarly situated individual attaches a ring 22 or a grommet 26 to the napkin and around the opening 20. In certain embodiments, an interior edge 24 of the ring or grommet defines the opening 20 and may even form the opening, such as to cut a hole in a napkin or fabric material upon attachment. The ring 22 or grommet 26 may be of a variety of shapes, sizes, and colors, as previously disclosed herein, thereby providing the manufacturer a sufficient degree of flexibility to offer a diverse product line to potential consumers. In certain embodiments, the manufacturer may operatively attach the ring 22 or grommet 26 to the napkin 10, while in other embodiments, the ring 22 or grommet 26 may be attached such that it remains subsequently removable and attachable at the discretion of a potential consumer.

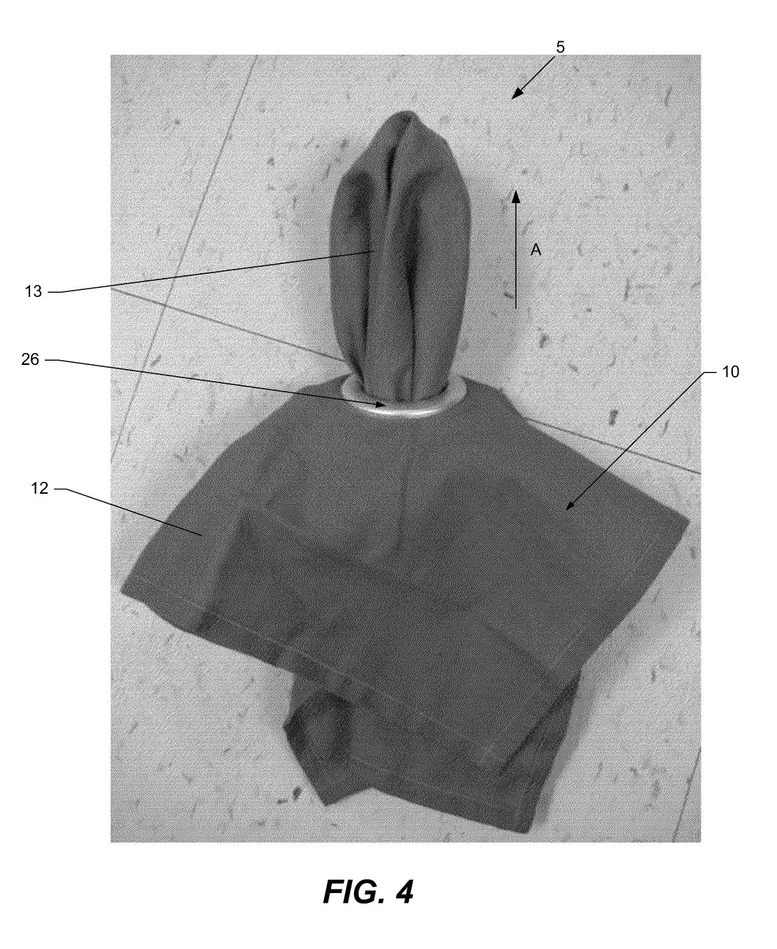

In various embodiments, to use the napkin and ring assembly 5, a user takes hold of a portion of the napkin 10 located on a first surface 12 of the napkin, as illustrated in FIG. 2A. The user then, still holding the portion of the napkin 10, inserts the portion through the opening 20 in a similar manner as known and understood in the arts. Next, the user turns over the napkin 10 such that a second surface 13 of the napkin is facing the user, as illustrated in FIG. 2B. The user then takes hold of the portion previously inserted through the opening 20 and continues to pull the portion through the opening until a desirable amount of the portion has passed through the opening 20, as illustrated in FIG. 4. The user may then arrange the remaining portions of the napkin 10 (i.e., those portions not pulled through the opening 20), such that the remaining portions create an aesthetic design or display, such as, for example, a flair shape as known and understood in the arts. In other embodiments, the user may alternatively take hold of a portion of the second surface 13 of the napkin 10 for insertion through the opening 20 and then continue to pull that portion through the opening relative to the first surface 12. In various embodiments, the portion of the napkin inserted through the opening by the user may be adjacent a center of the napkin, or alternatively adjacent one or more corners or edges of the napkin, depending on the aesthetic design or display desired by the user.

In various embodiments having a ring 22 or a grommet 26, a user inserts and continues to pull a portion of the napkin 10 through the ring or grommet in a similar fashion as disclosed above with respect to the opening 20. In certain of these embodiments, the user may select which surface (e.g., first or second surfaces 12 or 13) to insert through the ring 22 or grommet 26 based upon which side of the ring or grommet the user wishes to be visible when the assembly 5 is in its final orientation, as shown, for example, in FIG. 4. For example, in an embodiment having a grommet 26 with a first side 27 that is constructed of brass and a second side 28 that is constructed of silver, a user may choose to orient the napkin 10 through the grommet such that the brass side 27 remains visible. Such may be desirable when items, such as, for example, dinner plates and wine glasses, accompanying the napkin and ring assembly 5 include brass features or elements. Alternatively, a user of the same embodiment may wish to have the second silver side 28 visible when other items, such as, for example, fine silverware or crystal glasses, accompanying the napkin and ring assembly 5 include features or elements best accented by the silver side 28. In still other embodiments, a variety of options may be selected by a user, including the shape, size, color, and material of the ring 22 or grommet 26 included in the napkin and ring assembly 5, as known and understood in the art.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A napkin and ring assembly comprising:
a napkin having a center and a perimeter; and
an opening in the napkin, a center of the opening located at a position offset from the center of the napkin.

2. The napkin and ring assembly of claim 1, wherein a periphery of the opening is sewn.

3. The napkin and ring assembly of claim 1, wherein the opening is substantially circular.

4. The napkin and ring assembly of claim 1, wherein the opening is substantially square.

5. The napkin and ring assembly of claim 1, wherein the opening is substantially a slit.

6. The napkin and ring assembly of claim 1, wherein the napkin is substantially square and the perimeter comprises four sides.

7. The napkin and ring assembly of claim 1, wherein:
the napkin is substantially square and the perimeter comprises four sides; and
the center of the opening is located at a position equidistant to two adjacent sides of the perimeter.

8. The napkin and ring assembly of claim 1, wherein:
the napkin is substantially square and the perimeter comprises four sides; and
the offset position of the center of the opening is located a distance from the perimeter, wherein the distance is approximately ⅛ to ⅜ of a length of one of the four sides.

9. The napkin and ring assembly of claim 1, wherein:
the napkin is substantially square and the perimeter comprises four sides, wherein a length of each of the four sides is approximately eighteen inches (18″); and
the offset position of the center of the opening is located a distance from the perimeter, wherein the distance is approximately four and a half inches (4.5″).

10. The napkin and ring assembly of claim 8, wherein the distance is approximately ¼ the length of the one of the four sides.

11. The napkin and ring assembly of claim 1, wherein:
the napkin is substantially circular; and
the offset position of the center of the opening is located a distance from the perimeter, wherein the distance is approximately ⅛ to ¾ of a radius of the napkin.

12. The napkin and ring assembly of claim 11, wherein the distance is ½ of the radius.

13. The napkin and ring assembly of claim 1, wherein the assembly further comprises a decoration attached around a circumference of the opening.

14. The napkin and ring assembly of claim 13, wherein the decoration is a ribbon.

15. The napkin and ring assembly of claim 1, wherein the assembly further comprises a ring having an interior circumference defining the opening.

16. The napkin and ring assembly of claim 15, wherein:
the interior circumference of the ring is substantially circular; and
an exterior of the ring is substantially circular.

17. The napkin and ring assembly of claim 15, wherein:
the interior circumference of the ring is substantially square; and
an exterior of the ring is substantially square.

18. The napkin and ring assembly of claim 15, wherein:
the interior circumference of the ring is substantially circular; and
an exterior of the ring is substantially square.

19. The napkin and ring assembly of claim 15, wherein the ring comprises a grommet.

20. The napkin and ring assembly of claim 19, wherein the grommet comprises a plastic.

21. The napkin and ring assembly of claim 19, wherein the grommet comprises a ceramic.

22. The napkin and ring assembly of claim 19, wherein the grommet comprises a metal.

23. The napkin and ring assembly of claim 19, wherein the grommet comprises a first side portion and a second side portion.

24. The napkin and ring assembly of claim 23, wherein the grommet is selectively removable from and selectively attachable to the napkin.

25. The napkin and ring assembly of claim 23, wherein the first and second side portions are different colors.

26. The napkin and ring assembly of claim 23, wherein the first and second side portions are different materials.

27. A method of manufacturing a napkin and ring assembly, the method comprising forming an opening in a napkin having a center and a perimeter, a center of the opening located in a position offset from the center of the napkin.

28. The method of claim 27, wherein forming the opening comprises positioning the center of the opening at a distance from the perimeter, wherein the distance is less than ⅜ of a length of the perimeter.

29. The method of claim 28, wherein forming the opening comprises sewing the napkin around an exterior circumference of the opening.

30. The method of claim 27, wherein the method further comprises attaching a ring to the napkin and around the opening such that an interior circumference of the ring defines the opening.
